(19) United States
(12) Patent Application Publication
(10) Pub. No.: US 2023/0339778 A1
(43) Pub. Date: Oct. 26, 2023

(54) LOW-RESIDUAL-ALKALI HIGH-NICKEL TERNARY POSITIVE-ELECTRODE MATERIAL AS WELL AS PREPARATION METHOD AND USE THEREOF

(71) Applicant: YIBIN LIBODE NEW MATERIAL CO., LTD, Yibin (CN)

(72) Inventors: Bin ZHANG, Yibin (CN); Weifeng FAN, Yibin (CN); Zheng CHENG, Yibin (CN); Qicai ZHU, Yibin (CN); Haojie FAN, Yibin (CN); Zhengqiang WANG, Yibin (CN)

(73) Assignee: YIBIN LIBODE NEW MATERIAL CO., LTD, Yibin (CN)

(21) Appl. No.: 18/304,044

(22) Filed: Apr. 20, 2023

(30) Foreign Application Priority Data
Apr. 22, 2022 (CN) 202210424265.9

(51) Int. Cl. C01G 53/00; H01M 4/525; H01M 4/505

(52) U.S. Cl. CPC C01G 53/50; H01M 4/525; H01M 4/505; C01P 2002/52; C01P 2006/40; C01P 2004/80

(57) ABSTRACT

Provided are low-residual-alkali high-nickel ternary positive-electrode material, preparation method and application thereof. The preparation method of a low-residual-alkali high-nickel ternary positive-electrode material includes: presintering a nickel-containing precursor and a lithium salt to obtain a presintered material, and performing primary high-temperature sintering on the presintered material and a dopant, wherein the presintering is controlled to be performed under a micro-negative pressure condition, such that water of the lithium salt and carbon dioxide generated by a primary reaction of the precursor and the lithium salt can be fully discharged. The primary high-temperature sintering is first controlled to be performed under a micro-negative pressure condition, such that a large amount of water and carbon dioxide generated by a reaction are discharged, and then, the sintering is performed under a micro-positive pressure, such that the reaction is fully performed to obtain a semi-finished ternary material with a complete structure.

### CROSS-REFERENCE TO RELATED APPLICATION

The present disclosure claims the priority to the Chinese patent application with the filing No. 2022104242659, filed on Apr. 22, 2022 with the China National Intellectual Property Administration, and entitled “LOW-RESIDUAL-ALKALI HIGH-NICKEL TERNARY POSITIVE-ELECTRODE MATERIAL AS WELL AS PREPARATION METHOD AND USE THEREOF”, the contents of which are incorporated by reference herein in entirety.

### TECHNICAL FIELD

The present disclosure relates to the field of lithium battery technologies, and particularly to a low-residual-alkali high-nickel ternary positive-electrode material as well as a preparation method and use thereof.

### BACKGROUND ART

As is well known, with an increase of a content of nickel in a ternary material, a sintered product has an increasing residual alkali content, which is one of the most important reasons why a high-nickel material cannot be industrialized. The high residual alkali content may cause high requirements on a production environment and a process control capability, in which jelly is easily caused after a slurry absorbs water, and a great difficulty occurs in a practical application. Therefore, a reduction of the surface residual alkali content is of great significance for the application of the ternary material in a battery.

Currently, excessive alkalinity on a surface of the high-nickel ternary material is mainly reduced from the following several aspects.

(1) In a lithium mixing and sintering stage, a lithium salt proportion is reduced, and a sintering schedule is adjusted, so as to enable lithium to diffuse into a crystal rapidly, but the reduction of the lithium proportion reduces the capacity.

(2) A material is washed by water and then subjected to secondary sintering to reduce the surface residual alkali content, but part of electrical performance will be correspondingly lost. This method is commonly used in current commerce, but this method causes lacking of lithium on the surface of the material, and part of the electrical performance is correspondingly lost. Meanwhile, the process of washing by water is complex and causes a certain amount of loss, thus increasing a production cost.

In view of this, the present disclosure is particularly proposed.

### SUMMARY

An object of the present disclosure is to provide a preparation method of a low-residual-alkali high-nickel ternary positive-electrode material, which is intended to remarkably reduce residual alkali without influencing electrical performances of a product and meanwhile avoid increasing complex process flows.

A second object of the present disclosure is to provide a low-residual-alkali high-nickel ternary positive-electrode material which has a low-residual-alkali characteristic and good electrical performances.

A third object of the present disclosure is to provide use of the above low-residual-alkali high-nickel ternary positive-electrode material in preparation of a lithium ion battery.

The disclosure is implemented as follows.

In a first aspect, the present disclosure provides a preparation method of a low-residual-alkali high-nickel ternary positive-electrode material, including: presintering a nickel-containing precursor and a lithium salt to obtain a presintered material, and performing primary high-temperature sintering on the presintered material and a dopant,
wherein the presintering is performed under a micro-negative pressure condition of −15 Pa to −2 Pa, and a presintering temperature is 450-550° C.;
the primary high-temperature sintering is performed under a micro-negative pressure condition of −10 Pa to −0.1 Pa and then a micro-positive pressure condition of 0.1-10 Pa, and a sintering temperature is controlled to be 700-850° C. in the primary high-temperature sintering process.

In an optional embodiment, the presintering is performed under a micro-negative pressure condition of −12 Pa to −3 Pa, and the primary high-temperature sintering is performed under a micro-negative pressure condition of −8 Pa to −1 Pa and then a micro-positive pressure condition of 1-8 Pa;
preferably, the presintering is performed under a micro-negative pressure condition of −10 Pa to −5 Pa, the primary high-temperature sintering is performed for 4-6 h under a micro-negative pressure condition of −5 Pa to −1 Pa and then performed under a micro-positive pressure condition of 1-5 Pa, and a total sintering time of the primary high-temperature sintering is controlled to be 8-12 h.

In an optional embodiment, the presintered material is crushed and then mixed with the dopant for the primary high-temperature sintering, and the sintering temperature is controlled to be 750-800° C.;
preferably, in the primary high-temperature sintering process, a temperature is raised to the sintering temperature at a temperature raising rate of 2-4° C./min, and a volume fraction of oxygen in a sintering atmosphere is controlled to be more than 95%.

In an optional embodiment, the dopant is at least one selected from compounds containing Zr, Al, Ti, Sr, Mg, Y and B.

In an optional embodiment, the presintering process includes: mixing the precursor and the lithium salt according to a lithium proportion of 1.03-1.07, and controlling the presintering temperature to be 480-520° C. and the sintering time to be 4-6 h; controlling the volume fraction of the oxygen in the sintering atmosphere to be more than 95% in the presintering process;
preferably, the precursor is a nickel-cobalt-manganese precursor.

In an optional embodiment, the method further includes: performing secondary high-temperature sintering on the material after the primary high-temperature sintering and a coating agent, wherein the secondary high-temperature sintering is performed under a micro-positive pressure condition of 1-8 Pa;
preferably, the pressure of the secondary high-temperature sintering is 1-5 Pa.

In an optional embodiment, the material after the primary high-temperature sintering is crushed and then mixed with the coating agent for the secondary high-temperature sintering;
preferably, the secondary high-temperature sintering is controlled to have a sintering temperature of 200-600° C. and a sintering time of 6-10 h, and the volume fraction of the oxygen in the sintering atmosphere is controlled to be more than 95%.

In an optional embodiment, the coating agent is at least one selected from compounds containing Al, Ti, B, Zr, and W.

In a second aspect, the present disclosure provides a low-residual-alkali high-nickel ternary positive-electrode material prepared using the preparation method according to any one of the preceding embodiments.

In a third aspect, the present disclosure provides use of the low-residual-alkali high-nickel ternary positive-electrode material according to the foregoing embodiment in preparation of a lithium ion battery.

The present disclosure has the following beneficial effects: the precursor and the lithium salt are presintered, and then, the obtained material and the dopant are subjected to the primary high-temperature sintering; the presintering is controlled to be performed under the micro-negative pressure condition, such that water of the lithium salt and carbon dioxide generated by a primary reaction of the precursor and the lithium salt can be fully discharged; and the primary high-temperature sintering is first controlled to be performed under the micro-negative pressure condition, such that a large amount of water and carbon dioxide generated by a reaction are discharged, and then, the sintering is performed under the micro-positive pressure, such that the reaction is fully performed to obtain a semi-finished ternary material with a complete structure. The prepared product has a lower residual alkali value, the electrical performance of the material is guaranteed, and the process is simple, convenient and easy.

### DETAILED DESCRIPTION

To make the objectives, technical solutions and advantages of the embodiments of the present disclosure clearer, the technical solutions in the embodiments of the present disclosure are clearly and completely described below. The embodiments in which specific conditions are not given are performed according to conventional conditions or conditions suggested by manufacturers. The reagents or instruments used in the present disclosure, the manufacturers of which are not indicated, are the commercially available conventional products.

A positive-electrode material for a lithium ion battery is generally alkaline, such as a general high-nickel ternary positive-electrode material, and the higher a nickel content is, the higher a capacity is, and the higher a residual alkali content is. Alkaline substances mainly include lithium hydroxide and lithium carbonate. On the one hand, the alkaline substances are prone to absorb moisture to influence a homogenization effect of the material, and on the other hand, the alkaline substances are prone to react with an electrolyte solution at a high temperature to be decomposed to generate gas, so as to influence a safety performance of the battery.

In order to solve problems in the method for reducing residual alkali in the prior art, the inventor provides a solution with a simple, convenient and easy process, and the residual alkali can be remarkably reduced on the basis of guaranteeing electrical performances of a product.

The embodiment of the present disclosure provides a preparation method of a low-residual-alkali high-nickel ternary positive-electrode material, including the following steps:

S1: Presintering

A nickel-containing precursor and a lithium salt are presintered to obtain a presintered material, the presintering is performed under a micro-negative pressure condition of −15 Pa to −2 Pa, and a presintering temperature is 450-550° C. In the presintering process, a control means of a micro-negative pressure in a kiln is adopted, such that water of the lithium salt and carbon dioxide generated by a primary reaction of the precursor and the lithium salt can be fully discharged.

Specifically, the micro-negative pressure may be −15 Pa, −14 Pa, −13 Pa, −12 Pa, −11 Pa, −10 Pa, −9 Pa, −8 Pa, −7 Pa, −6 Pa, −5 Pa, −4 Pa, −3 Pa, −2 Pa, or the like, or any value between the above adjacent pressure values.

Specifically, the presintering temperature may be 450° C., 460° C., 470° C., 480° C., 490° C., 500° C., 510° C., 520° C., 530° C., 540° C., 550° C., or the like, or any value between the above adjacent temperature values.

In a preferred embodiment, the presintering is performed under the micro-negative pressure condition of −12 Pa to −3 Pa; in a more preferred embodiment, the presintering is performed under the micro-negative pressure condition of −10 Pa to −5 Pa. The water and the generated carbon dioxide can be fully discharged by further controlling the value of the micro-negative pressure, so as to prevent the generation of the residual alkali.

In a practical operation process, the presintering process includes: mixing the precursor and the lithium salt according to a lithium proportion of 1.03-1.07, and controlling the presintering temperature to be 480-520° C. and the sintering time to be 4-6 h; and controlling a volume fraction of oxygen in a sintering atmosphere to be more than 95% in the presintering process, so as to ensure that the reaction is more fully performed.

Specifically, the precursor may be a nickel-cobalt-manganese precursor, or the like, which is a conventional positive-electrode material precursor. The lithium proportion may be 1.03, 1.04, 1.05, 1.06, 1.07, or the like, or any value between the above adjacent lithium proportions.

Specifically, the presintering time may be 4 h, 4.5 h, 5 h, 5.5 h, 6 h, or the like, or any value between the above adjacent time values.

S2: Primary High-Temperature Sintering

The presintered material and a dopant are subjected to the primary high-temperature sintering, a sintering temperature is controlled to be 700-850° C. in the primary high-temperature sintering process, and the sintering is first performed under a micro-negative pressure condition of −10 Pa to −0.1 Pa and then a micro-positive pressure condition of 0.1-10 Pa. First, high-temperature sintering is performed under the micro-negative pressure condition, a large amount of water and carbon dioxide generated by a reaction are discharged, and then, the reaction is fully performed under the micro-positive pressure sintering condition, so as to obtain a semi-finished ternary material with a complete structure.

Specifically, the temperature of the primary high-temperature sintering may be 700° C., 710° C., 720° C., 730° C., 740° C., 750° C., 760° C., 770° C., 780° C., 790° C., 800° C., 810° C., 820° C., 830° C., 840° C., 850° C., or the like, or any value between the above adjacent temperature values.

Specifically, the micro-negative pressure may be −10 Pa, −9 Pa, −8 Pa, −7 Pa, −6 Pa, −5 Pa, −4 Pa, −3 Pa, −2 Pa, −1 Pa, −0.1 Pa, or the like, or any value between the above adjacent pressure values. The micro-positive pressure may be 0.1 Pa, 1 Pa, 2 Pa, 3 Pa, 4 Pa, 5 Pa, 6 Pa, 7 Pa, 8 Pa, 9 Pa, 10 Pa, or the like, or any value between the above adjacent pressure values.

In a preferred embodiment, the primary high-temperature sintering is performed under a micro-negative pressure condition of −8 Pa to −1 Pa and then a micro-positive pressure condition of 1-8 Pa.

In a more preferred embodiment, the primary high-temperature sintering is performed for 4-6 h (for example, 4 h, 5 h, 6 h, or the like) under a micro-negative pressure condition of −5 Pa to −1 Pa and then performed under a micro-positive pressure condition of 1-5 Pa, and a total sintering time of the primary high-temperature sintering is controlled to be 8-12 h (for example, 8 h, 9 h, 10 h, 11 h, 12 h, or the like). By further controlling the operation pressure and the micro-negative-pressure operation time of the primary high-temperature sintering, the water and carbon dioxide generated by the reaction can be more fully discharged, and the content of the residual alkali in the product is reduced without prolonging the total sintering time remarkably.

In a preferred embodiment, the presintered material is crushed and then mixed with the dopant for the primary high-temperature sintering, and the sintering temperature is controlled to be 750-800° C.; in the primary high-temperature sintering process, a temperature is raised to the sintering temperature at a temperature raising rate of 2-4° C./min; and in the primary high-temperature sintering process, the volume fraction of the oxygen in the sintering atmosphere is controlled to be more than 95%. The electrical performance of the product can be further improved by optimizing the temperature, the temperature raising rate and the atmosphere of the primary high-temperature sintering.

In some embodiments, the dopant is at least one selected from compounds containing Zr, Al, Ti, Sr, Mg, Y and B, and the compounds may be general oxides, hydroxides, or the like. Doping using conventional doping elements falls within the protection scope of the present disclosure, and the doping elements are not limited to the above elements.

S3: Secondary High-Temperature Sintering

The material after the primary high-temperature sintering and a coating agent are subjected to secondary high-temperature sintering, and the secondary high-temperature sintering is performed under a micro-positive pressure condition of 1-8 Pa, such that a cycle performance of the material is further improved using the secondary high-temperature sintering.

Specifically, the micro-positive pressure may be 1 Pa, 2 Pa, 3 Pa, 4 Pa, 5 Pa, 6 Pa, 7 Pa, 8 Pa, or the like, or any value between the above adjacent pressure values. In a preferred embodiment, the pressure of the secondary high-temperature sintering is 1-5 Pa, such that the reaction is fully performed, and the semi-finished product is uniformly coated with the material.

In a practical operation process, the material after the primary high-temperature sintering is crushed, and then, the material is mixed with the coating agent for the secondary high-temperature sintering. The coating uniformity degree is improved through crushing, and the cycle performance of the material is further improved.

Further, the secondary high-temperature sintering is controlled to have a sintering temperature of 200-600° C. and a sintering time of 6-10 h, and the volume fraction of the oxygen in the sintering atmosphere is controlled to be more than 95%. Control over the temperature, time and atmosphere of the secondary high-temperature sintering facilitates an improvement of the cycle performance of the final product.

Specifically, the coating agent is at least one selected from compounds containing Al, Ti, B, Zr, and W. The compounds can be common oxides, hydroxides, or the like. The above conventional coating agents are all suitable for coating of the semi-finished product after the primary high-temperature sintering, and the cycle performance of the material can be obviously improved.

The embodiment of the present disclosure provides a low-residual-alkali high-nickel ternary positive-electrode material, which is prepared using the above preparation method, has advantages of low residual alkali and good electrical performances, and can be further prepared into a lithium ion battery, which has a wide application prospect.

The features and performances of the present disclosure are described in further detail below with reference to examples.

### Example 1

The present example provided a preparation method of a low-residual-alkali high-nickel ternary positive-electrode material, including the following steps:

(1) presintering: a Ni_{0.8}Co_{0.1}Mn_{0.1}(OH)₂ precursor and a lithium salt were weighed with a lithium proportion of 1.05, and the raw materials were mixed and then placed in a roller kiln atmosphere for presintering, wherein a presintering temperature was 500° C., a sintering time was 5 h, an oxygen concentration in the sintering atmosphere was more than 95%, and a sintering pressure was a micro-negative pressure of −8 Pa. The presintered material was obtained after the presintering was finished.

(2) primary high-temperature sintering: the presintered material was crushed, and dopants ZrO₂ and Al₂O₃ were added and mixed with the presintered material, wherein an adding amount of Zr was controlled to be 2,000 ppm, and an adding amount of Al was controlled to be 1,000 ppm. The mixed material was placed in the roller kiln atmosphere for sintering, wherein a temperature was raised to 780° C. at a temperature raising rate of 3° C./min, sintering was performed for 10 h, and the oxygen concentration in the sintering atmosphere was more than 95%; and the sintering was first performed for 5 h under a micro-negative pressure of −3 Pa and then performed at micro-positive pressure of 3 Pa, so as to obtain a semi-finished ternary material.

(3) secondary high-temperature sintering: the semi-finished ternary material was crushed and mixed with a coating agent H₂BO₃, and an addition amount of B was controlled to be 1,000 ppm. The mixed material was placed in the roller kiln atmosphere for sintering, wherein a sintering temperature was 260° C., a sintering time was 8 h, the oxygen concentration in the sintering atmosphere was more than 95%, and a micro-positive pressure was 3 Pa, so as to obtain the finished ternary material.

### Example 2

The present example provided a preparation method of a low-residual-alkali high-nickel ternary positive-electrode material, which was different from example 1 in pressure control in the process, and was the same as example 1 except for the following parameters, specifically as follows:
(1) presintering: the sintering pressure was a micro-negative pressure of −12 Pa.
(2) primary high-temperature sintering: the sintering was first performed for 5 h under a micro-negative pressure of −8 Pa and then performed under a micro-positive pressure of 1 Pa, so as to obtain a semi-finished ternary material.
(3) secondary high-temperature sintering: the micro-positive pressure was controlled to be 1 Pa.

### Example 3

The present example provided a preparation method of a low-residual-alkali high-nickel ternary positive-electrode material, which was different from example 1 in pressure control in the process, specifically as follows:
(1) presintering: the sintering pressure was a micro-negative pressure of −3 Pa.
(2) primary high-temperature sintering: the sintering was first performed for 5 h under a micro-negative pressure of −1 Pa and then performed under a micro-positive pressure of 8 Pa, so as to obtain a semi-finished ternary material.
(3) secondary high-temperature sintering: the micro-positive pressure was 5 Pa.

### Example 4

The present example provided a preparation method of a low-residual-alkali high-nickel ternary positive-electrode material, which was different from example 1 in pressure control in the process, and was the same as example 1 except for the following parameters, specifically as follows:
(1) presintering: the sintering pressure was a micro-negative pressure of −15 Pa.
(2) primary high-temperature sintering: the sintering was first performed for 5 h under a micro-negative pressure of −10 Pa and then performed under a micro-positive pressure of 0.1 Pa, so as to obtain a semi-finished ternary material.
(3) secondary high-temperature sintering: the micro-positive pressure was controlled to be 1 Pa.

### Example 5

The present example provided a preparation method of a low-residual-alkali high-nickel ternary positive-electrode material, which was different from example 1 in pressure control in the process, and was the same as example 1 except for the following parameters, specifically as follows:
(1) presintering: the sintering pressure was a micro-negative pressure of −2 Pa.
(2) primary high-temperature sintering: the sintering was first performed for 5 h under a micro-negative pressure of −0.1 Pa and then performed under a micro-positive pressure of 10 Pa, so as to obtain a semi-finished ternary material.
(3) secondary high-temperature sintering: the micro-positive pressure was controlled to be 8 Pa.

It should be noted that the above examples are only examples of many examples tested by the inventor, and other examples of the dopants, coating agents, quantities, temperatures, and time are not listed one by one here.

### Comparative Example 1

Comparative Example 1 was different from example 1 only in that: the pressure in the presintering process was −25 Pa.

### Comparative Example 2

Comparative Example 2 was different from example 1 only in that: the pressure in the presintering process was 10 Pa.

### Comparative Example 3

Comparative Example 3 was different from example 1 only in that: the pressure in the primary high-temperature sintering process was −15 Pa.

### Comparative Example 4

Comparative Example 4 was different from example 1 only in that: the pressure in the primary high-temperature sintering process was 10 Pa.

### Comparative Example 5

Comparative Example 5 was different from example 1 only in that: sintering under the micro-negative pressure was not performed, and the pressure of the primary high-temperature sintering process was 3 Pa.

### Test Example 1

The electrical performances and residual alkali values of the positive-electrode materials obtained in the examples and the comparative examples were tested, and test results were shown in Table 1.

TABLE 1
Test results of electrical performances
and residual alkali contents

| | | | 0.1C |
|---|---|---|---|
| Group | LiOH/ppm | LiCO₃/ppm | capacity/mAh/g |
| Example 1 | 1211 | 898 | 213.8 |
| Example 2 | 1235 | 838 | 212.2 |
| Example 3 | 1524 | 936 | 212.6 |
| Example 4 | 1128 | 792 | 211.8 |
| Example 5 | 1435 | 1023 | 210.5 |
| Comparative | 1256 | 786 | 208.1 |
| Example 1 | | | |
| Comparative | 2263 | 1120 | 211.6 |
| Example 2 | | | |
| Comparative | 1226 | 801 | 206.4 |
| Example 3 | | | |
| Comparative | 2682 | 1225 | 212.4 |
| Example 4 | | | |
| Comparative | 3382 | 3065 | 211.0 |
| Example 5 | | | |

It can be seen from Table 1 that the method according to the embodiment of the present disclosure can significantly reduce the residual alkali value of the material without affecting the electrical performances of the material, and if operating parameters of the pressure are beyond the range of the present application, the performance will be reduced.

The above description is only preferred embodiments of the present disclosure and is not intended to limit the present disclosure, and various modifications and changes may be made to the present disclosure by those skilled in the art. Any modification, equivalent replacement, or improvement made within the spirit and principle of the present disclosure shall be included in the protection scope of the present disclosure.

What is claimed is:

1. A preparation method of a low-residual-alkali high-nickel ternary positive-electrode material, comprising: presintering a nickel-containing precursor and a lithium salt to obtain a presintered material, and performing a primary high-temperature sintering on the presintered material and a dopant,
wherein the presintering is performed under a micro-negative pressure condition of −15 Pa to −2 Pa, and a presintering temperature is 450-550° C.; and
the primary high-temperature sintering is performed under a micro-negative pressure condition of −10 Pa to −0.1 Pa and then a micro-positive pressure condition of 0.1-10 Pa, and a sintering temperature is controlled to be 700-850° C. in a process of the primary high-temperature sintering.

2. The preparation method according to claim 1, wherein the presintering is performed under a micro-negative pressure condition of −12 Pa to −3 Pa, and the primary high-temperature sintering is performed under a micro-negative pressure condition of −8 Pa to −1 Pa and then a micro-positive pressure condition of 1-8 Pa.

3. The preparation method according to claim 2, wherein the presintered material is crushed and then mixed with the dopant for the primary high-temperature sintering, and the sintering temperature is controlled to be 750-800° C.; and
in the process of the primary high-temperature sintering, a temperature is raised to the sintering temperature at a temperature raising rate of 2-4° C./min, and a volume fraction of oxygen in a sintering atmosphere is controlled to be more than 95%.

4. The preparation method according to claim 3, wherein the dopant is at least one selected from compounds containing Zr, Al, Ti, Sr, Mg, Y and B.

5. The preparation method according to claim 2, wherein a process of the presintering comprises: mixing the precursor and the lithium salt according to a lithium proportion of 1.03-1.07, and controlling the presintering temperature to be 480-520° C. and a sintering time to be 4-6 h; and controlling a volume fraction of oxygen in a sintering atmosphere to be more than 95% in the process of the presintering; and
the precursor is a nickel-cobalt-manganese precursor.

6. The preparation method according to claim 1, further comprising: performing a secondary high-temperature sintering on a material after the primary high-temperature sintering and a coating agent, the secondary high-temperature sintering being performed under a micro-positive pressure condition of 1-8 Pa.

7. The preparation method according to claim 6, wherein the material after the primary high-temperature sintering is crushed and then mixed with the coating agent for the secondary high-temperature sintering; and
the secondary high-temperature sintering is controlled to have a sintering temperature of 200-600° C. and a sintering time of 6-10 h, and a volume fraction of oxygen in a sintering atmosphere is controlled to be more than 95%.

8. The preparation method according to claim 7, wherein the coating agent is at least one selected from compounds containing Al, Ti, B, Zr, and W.

9. A low-residual-alkali high-nickel ternary positive-electrode material, prepared using the preparation method according to claim 1.

10. Use of the low-residual-alkali high-nickel ternary positive-electrode material according to claim 9 in preparation of a lithium ion battery.

11. The preparation method according to claim 2, further comprising: performing a secondary high-temperature sintering on a material after the primary high-temperature sintering and a coating agent, the secondary high-temperature sintering being performed under a micro-positive pressure condition of 1-8 Pa.
